(19) United States
(12) Patent Application Publication
(10) Pub. No.: US 2025/0117851 A1
(43) Pub. Date: Apr. 10, 2025

(54) Target-Based Dynamic Market Making System

(71) Applicant: Noah Gil Severs, Bangkok (TH)

(72) Inventor: Noah Gil Severs, Bangkok (TH)

(21) Appl. No.: 18/986,809

(22) Filed: Dec. 19, 2024

(51) Int. Cl. G06Q 40/04; G06Q 40/06

(52) U.S. Cl. CPC G06Q 40/04; G06Q 40/06

(57) ABSTRACT

A target-based market making system that automatically manages asset pool positions through mathematically defined phases. The system determines position sizes using distribution functions relative to configured target prices, creating systematic sell pressure as prices approach those targets. Unlike traditional constant-product pools or derivative-based approaches, the system directly manages assets using phase transitions triggered by price-to-target ratios, maintaining full collateralization while enabling automated capture of value from price movements. The mathematical framework supports various distribution functions while preserving core position management mechanics.

### CROSS-REFERENCE TO RELATED APPLICATIONS

Not Applicable

### STATEMENT REGARDING FEDERALLY SPONSORED RESEARCH OR DEVELOPMENT Not Applicable

### REFERENCE TO SEQUENCE LISTING, A TABLE, OR A COMPUTER PROGRAM LISTING COMPACT DISK APPENDIX

Not Applicable

### FIELD OF INVENTION

This invention relates to automated market making systems and specifically to dynamic asset pool management that adjusts positions using mathematically defined target prices. The invention has primary application in digital asset markets while being adaptable to any tradeable asset pairs requiring automated position management.

### BACKGROUND OF THE INVENTION

Automated market makers (AMMs) and decentralized exchanges (DEXs) facilitate digital asset trading on blockchain-based platforms, enabling participants to exchange tokens without reliance on traditional order books. These systems commonly utilize liquidity pools of asset pairs and smart contracts to facilitate trades. In many current implementations, however, dynamic liquidity management often depends on external data inputs or frequent human intervention. For example, certain blockchain-integrated trading solutions, including those disclosed in U.S. Pat. No. 11,436,677, incorporate external pricing feeds or oracle services. Similarly, traditional portfolio management frameworks, such as those described in U.S. Pat. No. 8,626,639, often hinge on active management processes and external references to maintain balanced positions.

Current AMM implementations typically maintain fixed mathematical relationships between paired assets, which may affect how liquidity pools respond to directional market movements. When markets experience sustained price trends, these fixed relationships can influence how effectively liquidity providers' capital adapts to changing conditions. Relying on external price feeds and manual oversight to address these considerations can introduce additional complexity and potential points of failure. External data sources may be subject to latency, inaccuracies, or disruptions, which can affect the stability and efficiency of liquidity pools.

Accordingly, there is a recognized need for an enhanced liquidity pool management system capable of autonomously adjusting asset positions in response to market conditions and directional price movements without depending primarily on external price feeds. Such a solution would ideally harness mathematically derived internal principles to guide position changes based on market activity. By reducing external dependencies and introducing self-contained, rule-based allocation strategies, liquidity providers could participate in directional market opportunities while maintaining resilience in dynamic market conditions.

### BRIEF SUMMARY OF THE INVENTION

The present invention provides a system for autonomous digital asset position management through mathematically controlled liquidity pools that operate in distinct phases relative to defined price targets. The system improves capital efficiency by automatically adjusting position ratios according to predetermined mathematical distributions, enabling liquidity providers to capture value from directional price movements while maintaining asset security through mathematical guarantees.

The system determines position allocations through market-derived price information, operating without reliance on external price feeds for position management decisions. These allocations automatically adjust through accumulation and profit-taking phases, with each phase optimizing for different market conditions while maintaining collateralization through mathematical principles.

In various embodiments, the system includes smart contracts that create and manage liquidity pools accepting deposits of cryptocurrency pairs. These contracts implement position management components that execute trades according to mathematically defined thresholds and maintain target-relative ratios between paired assets, reducing risk while improving returns through automated rebalancing strategies.

Some embodiments provide mechanisms for liquidity providers to participate through specialized pool tokens representing proportional claims on pool assets. By automating position management through phase-based mathematical principles rather than manual intervention or external price feeds, the system enables efficient deployment of capital while protecting against common risks in digital asset markets.

### BRIEF DESCRIPTION OF THE DRAWINGS

FIG. 1 is a system architecture diagram illustrating an automated liquidity pool management system according to various embodiments, including smart contracts, liquidity reserves, and integration points with trading environments.

FIG. 2 is a graph illustrating example mathematical relationships that may guide position allocation based on price movements, according to one embodiment.

FIG. 3 is a state diagram showing transitions between operational phases based on pool conditions, according to various embodiments.

FIG. 4 is a flow diagram illustrating position management operations, including monitoring, rebalancing, and trade execution steps, according to an embodiment.

FIG. 5 is a block diagram depicting implementation across different blockchain environments and trading venues, according to various embodiments.

FIG. 6 is a diagram showing representation and management of pool positions through transferable tokens, according to an embodiment.

### DETAILED DESCRIPTION OF THE INVENTION

The present disclosure provides systems and methods for automated management of digital asset liquidity pools through mathematically controlled position targeting. A liquidity pool, as used herein, refers to a smart contract-managed reserve of paired digital assets that enables automated market making and trading. While various embodiments are described with reference to specific implementations, it will be understood by those skilled in the art that variations, modifications and alternative embodiments are contemplated.

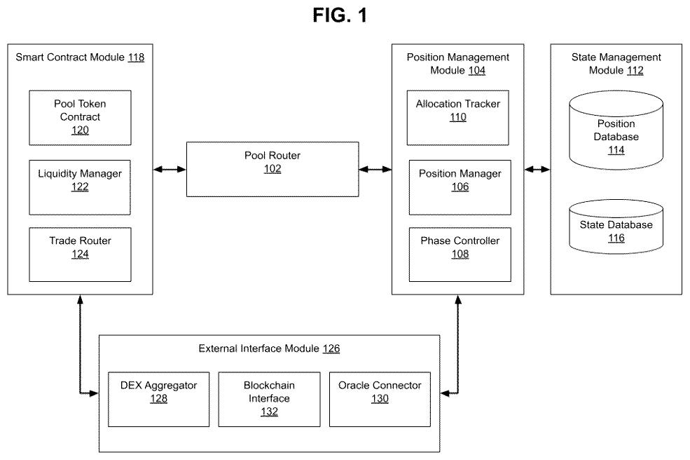

Referring first to FIG. 1, a liquidity pool system includes various modules and components that cooperate to provide automated pool management functionality. The system employs mathematical models to determine optimal asset allocations and automatically maintains these target positions through controlled trading operations.

A pool router 102 serves as the primary interface for directing operations between system components, handling all incoming liquidity events and outgoing trade execution requests. The router 102 enforces system protocols and ensures proper sequencing of operations. The system includes a position management module 104 that controls core pool operations through three specialized components. A position manager 106 maintains and adjusts asset allocations based on mathematically determined target ratios derived from configured price targets and distribution parameters. The position manager 106 calculates optimal allocations using mathematical models that define position targets based on price movement relative to predetermined thresholds.

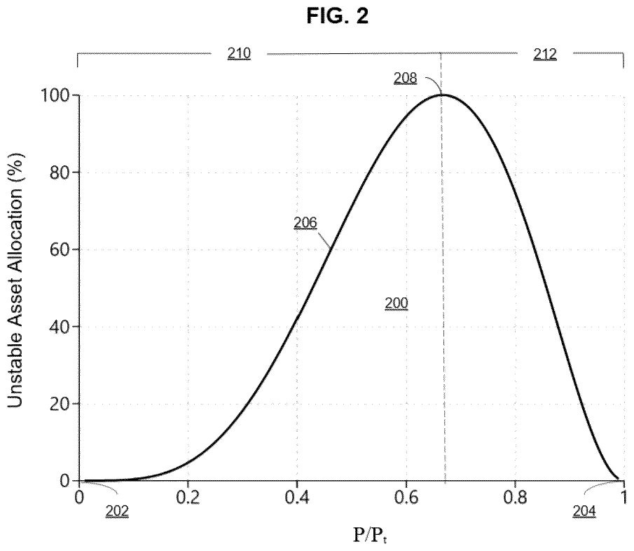

A phase controller 108 governs operational states and transitions based on mathematically defined thresholds relative to configured target prices. The phase controller 108 manages transitions between Consolidation (210) and Profit (212) phases, as shown in FIG. 2, optimizing pool behavior through mathematical position targeting as prices approach and exceed predetermined thresholds. The phase controller 108 determines appropriate operational phases based on internally calculated parameters and records phase transitions in the state database 116.

An allocation tracker 110 monitors actual versus target positions using data maintained in the position database 114. The tracker reports allocation divergences to the position manager 106, enabling automated rebalancing when positions deviate from mathematically determined targets by more than specified tolerances.

A state management module 112 provides persistent storage and tracking capabilities through its position database 114 and state database 116. The position database 114 maintains current holdings, target allocations, and historical position data needed for mathematical position calculations. The state database 116 records operational phases, rebalancing events, and other state changes required for system operation and audit purposes.

A smart contract module 118 implements the on-chain components of the system, including a pool token contract 120 for representing proportional pool ownership, a liquidity manager 122 for processing deposit and withdrawal operations, and a trade router 124 for executing position changes. These contracts interact through an external interface module 126 that optimizes operations across blockchain environments.

The external interface module 126 includes a DEX aggregator 128 that optimizes trade execution across venues by finding the most efficient routing and pricing. In some embodiments, the system may optionally utilize external market data through an oracle connector 130, though the core position management functionality operates autonomously using on-chain data and mathematical models. A blockchain interface 132 manages on-chain interactions required for trade execution and state updates.

During operation, the position manager 106 continuously evaluates current allocations against mathematically determined targets. When the allocation tracker 110 reports that position divergence exceeds specified thresholds, the position manager 106 initiates rebalancing operations through the pool router 102. The phase controller 108 ensures these operations align with current market conditions by maintaining appropriate operational phases based on internally calculated parameters.

The described architecture enables implementation across different blockchain environments while maintaining consistent mathematical position management. Alternative arrangements are possible while preserving the core functionality of automated, mathematically-driven position targeting. Additional components may be included, different storage mechanisms employed, and various optimization strategies implemented within the scope of the disclosure.

The modules, components, and operations described herein may be implemented by one or more computing devices, each comprising one or more processors, memory, and non-transitory storage media. Instructions for executing the disclosed methods and operations may be stored in the non-transitory storage media and executed by the processors. The computing devices may operate as nodes in a distributed blockchain network executing smart contracts, or as dedicated hardware devices configured to perform the described position management operations. The specific hardware configuration is not limiting; the described functionality may be implemented across various computing architectures while maintaining the core mathematical relationships and operational phases described herein.

Referring now to FIG. 2, this figure illustrates one embodiment of a mathematical relationship (curve 200) between a normalized price progress ratio and an allocation strategy for a liquidity pool comprising a paired set of assets. In this context, one asset is considered “unstable” (e.g., more volatile) and the other comparatively more stable. The system dynamically adjusts allocations between these assets based on predetermined mathematical principles.

The horizontal axis (x-axis) represents the normalized price progress as P/Pₜ, where P is the current price of the unstable asset and Pₜ is a predefined target price. This normalization transforms absolute prices into a 0-to-1 scale. A value of 0 at point 202 corresponds to a scenario in which the unstable asset's price has effectively collapsed relative to the target price, resulting in negligible allocation of the unstable asset. A value of 1 at point 204 represents the situation where the unstable asset's price has reached the target price.

Between these extremes, the allocation curve 200 defines how the unstable asset allocation varies. In some embodiments, the system may commence operation at an initial price ratio indicated by point 206. From this initial ratio, if the price increases, the system follows the curve's logic, increasing unstable asset allocation until reaching a maximum at threshold point 208. When the price ratio is below 208, the system operates in a Consolidation Phase (region 210), accumulating the unstable asset in anticipation of potential gains. Beyond point 208, as the ratio approaches 1, the system enters a Profit Phase (region 212), systematically reducing unstable asset allocation to secure value in the stable asset.

If the price declines after the system has entered the Profit Phase and the ratio falls back below point 208, the system returns to the Consolidation Phase, reacting to downward movements by reducing unstable asset holdings and favoring the stable asset. This bidirectional adaptability enables the system to respond dynamically to both upward and downward trends. For example, the illustrated curve begins at near-zero price conditions with no unstable asset allocation, reaches a maximum allocation at an intermediate threshold, and then decreases as the target price is approached or if the price retraces downward. Including an exemplary initial price point (206) demonstrates that the system may commence operation at various price ratios without constraining its overall logic or functionality.

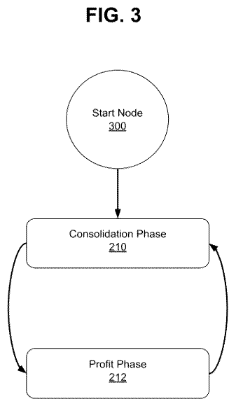

Referring now to FIG. 3, a state diagram illustrates operational phase transitions within the liquidity pool management system. In the illustrated embodiment, the system begins operation at a start node 300. The start node 300 represents an initial operational condition or baseline state from which the system initiates its allocation logic. From this start node 300, the system enters either the Consolidation Phase 210 or Profit Phase 212 based on initial conditions relative to threshold 208. During operation, transitions between phases may be triggered by various mathematical conditions including, but not limited to, the price ratio described in connection with FIG. 2.

During Consolidation Phase 210, the system may increase its allocation of the unstable asset as the price ratio moves upward, preparing for potential gains if the price continues to rise. When the price ratio surpasses threshold 208, the system transitions to the Profit Phase 212. In the Profit Phase 212, the system systematically reduces its unstable asset holdings to capture gains as the price approaches the target.

If the price ratio subsequently declines and falls below threshold 208, the system re-enters Consolidation Phase 210, adapting its allocation strategy to changing market conditions. This state-based approach, in conjunction with the allocation logic described in FIG. 2, provides a structured mechanism for autonomously managing asset allocations. Although FIG. 3 depicts a two-phase model for illustrative purposes, alternative embodiments may employ additional states, multiple thresholds, or more complex transition criteria based on various mathematical conditions without departing from the broader principles of automated, mathematically driven position management.

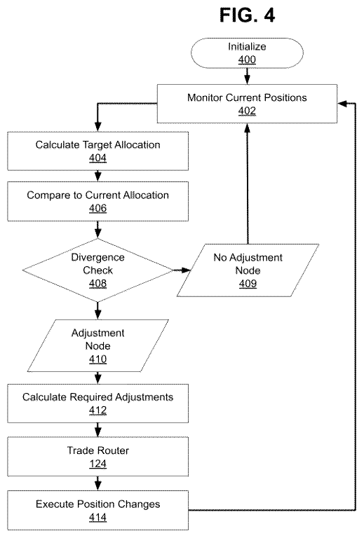

Referring now to FIG. 4, a flow diagram illustrates the operational process for position management within the liquidity pool system. The process begins at initialization point 400 and proceeds to a monitoring operation 402 that tracks current positions within the liquidity pool. This monitoring leverages the position database 114, described in connection with FIG. 1, to maintain the current allocation status.

A target allocation calculation operation 404 determines a mathematically derived optimal allocation based on current price progress, as discussed in connection with FIG. 2. A comparison operation 406 then evaluates the current positions against these calculated target allocations. At decision point 408, the system determines whether current allocations require adjustment. If no adjustment is required, as indicated by No Adjustment Node 409, the process returns to monitoring operation 402. If an adjustment is required, as indicated by Adjustment Node 410, the process advances to an adjustment calculation operation 412. This operation 412 determines the specific position changes needed to bring current allocations into alignment with the calculated targets. These calculated changes are then passed to the trade router 124 (previously described with respect to FIG. 1) to execute position changes 414.

After executing any required position changes, the process returns to monitoring operation 402, ensuring oversight and dynamic alignment of pool allocations. While FIG. 4 illustrates one example sequence of operations, alternative embodiments may incorporate additional steps, different calculation methodologies, or various optimization strategies, all while preserving the core principle of automated, mathematically driven position management.

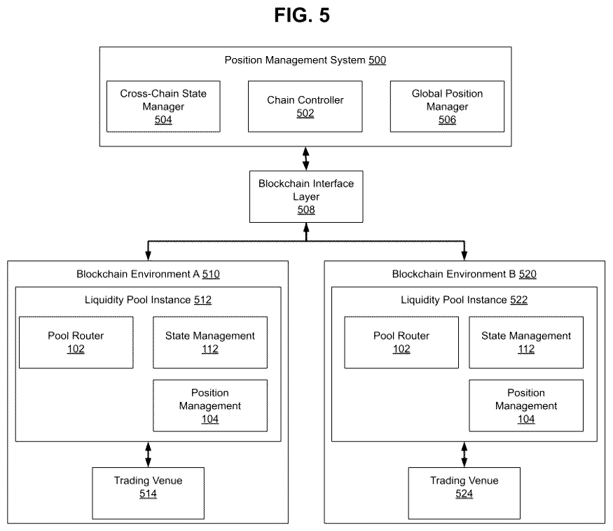

Referring now to FIG. 5, a block diagram illustrates one possible deployment architecture of the position management system across multiple blockchain environments. The cross-chain management system 500 coordinates liquidity pool operations across different blockchain implementations while maintaining consistent position management strategies.

A chain controller 502 coordinates cross-chain operations through a blockchain interface layer 508. The interface layer 508 may be implemented through various configurations including, but not limited to, a single unified interface, multiple blockchain-specific interfaces, or various API implementations depending on specific blockchain requirements and characteristics. This flexible interface approach enables adaptation to different blockchain protocols while maintaining consistent operational logic.

The chain controller 502 works in conjunction with a cross-chain state manager 504 and global position manager 506. The cross-chain state manager 504 synchronizes states across multiple blockchain networks, enabling interoperability of the system. The global position manager 506 oversees the aggregation and adjustment of liquidity positions across all connected trading venues and blockchains. These components may be implemented either as distinct system-level modules or as extended functionality of the pool router 102, state management 112, and position management 104 components previously described in connection with FIG. 1. This architectural flexibility enables the system to be deployed in various configurations while maintaining the core position management functionality.

Within blockchain environments (510, 520), liquidity pool instances (512, 522) may be managed either by dedicated pool routers 102 or by a unified routing system operating across multiple chains. The routing functionality, whether distributed or centralized, interfaces with respective trading venues (514, 524) to execute position adjustments while maintaining consistency with global position management strategies.

The interface layer 508 may adapt to specific blockchain requirements through various implementations while maintaining consistent position management logic. This enables the system to operate across any number of blockchain environments regardless of whether the core components are implemented in a distributed or centralized manner. The system architecture may be configured to optimize for specific deployment requirements while preserving the mathematical position management strategies previously described.

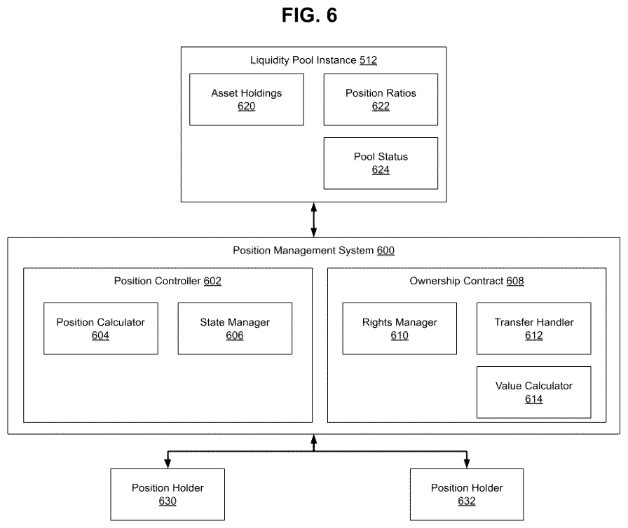

Referring now to FIG. 6, a diagram illustrates the representation and management of pool positions through ownership rights. A position management system 600 implements mechanisms for tracking and transferring claims on pool assets. The system maintains communication with liquidity pool instance 512 to coordinate position management operations.

A position controller 602 coordinates ownership operations through two primary components. A position calculator 604 determines position values based on current pool allocations and the mathematical management strategies previously described. A state manager 606 maintains the current state of all ownership claims and their relationship to pool assets.

The system implements ownership rights through an ownership contract 608 which may represent such claims through various digital asset standards including, but not limited to, fungible tokens and non-fungible tokens (NFTs). A rights manager 610 handles creation and removal of these claims. A transfer handler 612 facilitates the movement of ownership rights, and a value calculator 614 updates position values as underlying pool conditions and allocations change.

The position management system 600 maintains synchronization with liquidity pool instance 512, previously described in connection with FIG. 5. The pool's asset holdings 620, position ratios 622, and pool status 624 inform position valuations and ownership allocations. This enables position holders 630, 632 to maintain claims to pool assets as the system implements the mathematical management strategies previously described.

The system's architecture enables integration of mathematically driven allocation strategies with various ownership representation models, allowing implementation across different blockchain environments while maintaining the core position management functionality described in connection with previous figures.

While various embodiments have been described in the context of digital asset liquidity pools, the mathematical position management principles disclosed herein are not limited to such environments. For example, the system may be adapted for use in traditional commodities or futures markets, where tokenized contracts, digital certificates of ownership, or similar mechanisms can represent claims on underlying assets. In these contexts, the same mathematical distribution-based allocation strategies may apply, addressing volatility and liquidity management challenges analogous to those found in digital asset trading.

The position management system may be implemented through various technological approaches and infrastructures. While blockchain-based smart contracts represent one illustrative approach, the underlying mathematical principles and strategies are equally applicable in other automated systems capable of position adjustment and ownership tracking. The specific technological framework may vary depending on regulatory considerations, available market infrastructure, and the nature of the traded assets.

These examples are provided for illustration only and do not limit the scope of the disclosed innovation. The principles described herein may be adapted to diverse markets, asset classes, and technological environments. As markets evolve and new trading mechanisms emerge, the fundamental approach of mathematically guided position management may be configured to address novel requirements while preserving the core concepts and flexibility disclosed herein.

The invention claimed is:

1. A computer-implemented system for managing a liquidity pool comprising a first asset and a second asset, the system comprising:
one or more processors; and
a non-transitory computer-readable medium storing instructions that, when executed by the one or more processors, cause the system to:
(a) store a target price parameter for the first asset relative to the second asset;
(b) determine a price ratio by comparing a transaction-derived price of the first asset to the target price parameter, wherein the transaction-derived price is computed based on transaction activity within the liquidity pool;
(c) apply a mathematical distribution function using the price ratio to define at least one threshold that distinguishes a first operational phase from a second operational phase, wherein:
(i) in the first operational phase, occurring when the price ratio is below the at least one threshold, the system increases a proportion of the first asset relative to the second asset as the price ratio approaches the at least one threshold, and
(ii) in the second operational phase, occurring when the price ratio exceeds the at least one threshold, the system decreases a proportion of the first asset relative to the second asset as the price ratio moves beyond the at least one threshold;
(d) adjust quantities of the first and second assets in the liquidity pool according to the current operational phase, wherein external market data through an oracle is optional for operation; and
(e) execute trades through the liquidity pool based on the adjusted quantities.

2. The system of claim 1, wherein the mathematical distribution function comprises a continuous probability distribution that maps the price ratio to target proportions of the first and second assets.

3. The system of claim 1, wherein the at least one threshold is dynamically adjusted based on observed price volatility of the first asset.

4. The system of claim 1, wherein the at least one threshold is dynamically adjusted based on historical trading volume of the liquidity pool.

5. The system of claim 1, wherein the at least one threshold is dynamically adjusted based on market depth metrics derived from transaction data.

6. The system of claim 1, wherein ownership rights in the liquidity pool are represented by fungible tokens recorded in a distributed ledger.

7. The system of claim 1, wherein ownership rights in the liquidity pool are represented by non-fungible tokens recorded in a distributed ledger.

8. The system of claim 1, wherein the first asset comprises a tokenized representation of a commodity futures contract.

9. The system of claim 1, wherein the first asset comprises a tokenized representation of an equity instrument.

10. The system of claim 1, wherein the first asset comprises a tokenized representation of a fixed-income instrument.

11. The system of claim 1, further comprising:
maintaining separate instances of the liquidity pool on different blockchain networks;
applying the same target price parameter across all instances; and
coordinating asset allocations between the instances.

12. The system of claim 1, wherein determining the transaction-derived price comprises:
analyzing completed transactions involving the first asset;
calculating a volume-weighted average price; and
updating the price ratio based on the calculated volume-weighted average price.

13. The system of claim 1, further comprising maintaining a state database that records historical price ratios and phase transitions.

14. The system of claim 1, further comprising maintaining a state database that records allocation adjustments and trade executions.

15. The system of claim 1, wherein the mathematical distribution function is configured to optimize trade execution based on liquidity levels in the liquidity pool.

16. A computer-implemented method for managing a liquidity pool comprising a first asset and a second asset, the method comprising:
(a) storing a target price parameter for the first asset relative to the second asset;
(b) determining a price ratio by comparing a transaction-derived price of the first asset to the target price parameter, wherein the transaction-derived price is computed based on transaction activity within the liquidity pool;
(c) applying a mathematical distribution function using the price ratio to define at least one threshold that distinguishes a first operational phase from a second operational phase, wherein:
(i) in the first operational phase, occurring when the price ratio is below the at least one threshold, increasing a proportion of the first asset relative to the second asset as the price ratio approaches the at least one threshold, and
(ii) in the second operational phase, occurring when the price ratio exceeds the at least one threshold, decreasing the proportion of the first asset relative to the second asset as the price ratio moves beyond the at least one threshold;
(d) adjusting quantities of the first and second assets in the liquidity pool according to the current operational phase, wherein external market data through an oracle is optional for operation; and
(e) executing trades through the liquidity pool based on the adjusted quantities.

17. The method of claim 16, wherein the mathematical distribution function comprises a continuous probability distribution that maps the price ratio to target proportions of the first and second assets.

18. The method of claim 16, wherein the at least one threshold is dynamically adjusted based on observed price volatility of the first asset.

19. The method of claim 16, wherein the at least one threshold is dynamically adjusted based on historical trading volume of the liquidity pool.

20. The method of claim 16, wherein the at least one threshold is dynamically adjusted based on market depth metrics derived from transaction data.

21. The method of claim 16, wherein ownership rights in the liquidity pool are represented by fungible tokens recorded in a distributed ledger.

22. The method of claim 16, wherein ownership rights in the liquidity pool are represented by non-fungible tokens recorded in a distributed ledger.

23. The method of claim 16, wherein the first asset comprises a tokenized representation of a commodity futures contract.

24. The method of claim 16, wherein the first asset comprises a tokenized representation of an equity instrument.

25. The method of claim 16, wherein the first asset comprises a tokenized representation of a fixed-income instrument.

26. The method of claim 16, further comprising:
maintaining separate instances of the liquidity pool on different blockchain networks;
applying the same target price parameter across all instances; and
coordinating asset allocations between the instances.

27. The method of claim 16, wherein determining the transaction-derived price comprises:
analyzing completed transactions involving the first asset;
calculating a volume-weighted average price; and
updating the price ratio based on the calculated volume-weighted average price.

28. The method of claim 16, further comprising maintaining a state database that records historical price ratios and phase transitions.

29. The method of claim 16, further comprising maintaining a state database that records allocation adjustments and trade executions.

30. The method of claim 16, wherein the mathematical distribution function is configured to optimize trade execution based on liquidity levels in the liquidity pool.

31. A non-transitory computer-readable medium storing instructions that, when executed by one or more processors, cause the processors to:
(a) store a target price parameter for a first asset relative to a second asset in a liquidity pool;
(b) determine a price ratio by comparing a transaction-derived price of the first asset to the target price parameter, wherein the transaction-derived price is computed based on transaction activity within the liquidity pool;
(c) apply a mathematical distribution function using the price ratio to define at least one threshold that distinguishes a first operational phase from a second operational phase, wherein:
(i) in the first operational phase, occurring when the price ratio is below the at least one threshold, increase a proportion of the first asset relative to the second asset as the price ratio approaches the at least one threshold, and
(ii) in the second operational phase, occurring when the price ratio exceeds the at least one threshold, decrease the proportion of the first asset relative to the second asset as the price ratio moves beyond the at least one threshold;
(d) adjust quantities of the first and second assets in the liquidity pool according to the current operational phase, wherein external market data through an oracle is optional for operation; and
(e) execute trades through the liquidity pool based on the adjusted quantities.

32. The non-transitory computer-readable medium of claim 31, wherein the mathematical distribution function comprises a continuous probability distribution that maps the price ratio to target proportions of the first and second assets.

33. The non-transitory computer-readable medium of claim 31, wherein the at least one threshold is dynamically adjusted based on observed price volatility of the first asset.

34. The non-transitory computer-readable medium of claim 31, wherein the at least one threshold is dynamically adjusted based on historical trading volume of the liquidity pool.

35. The non-transitory computer-readable medium of claim 31, wherein the at least one threshold is dynamically adjusted based on market depth metrics derived from transaction data.

36. The non-transitory computer-readable medium of claim 31, wherein ownership rights in the liquidity pool are represented by fungible tokens recorded in a distributed ledger.

37. The non-transitory computer-readable medium of claim 31, wherein ownership rights in the liquidity pool are represented by non-fungible tokens recorded in a distributed ledger.

38. The non-transitory computer-readable medium of claim 31, wherein the first asset comprises a tokenized representation of a commodity futures contract.

39. The non-transitory computer-readable medium of claim 31, wherein the first asset comprises a tokenized representation of an equity instrument.

40. The non-transitory computer-readable medium of claim 31, wherein the first asset comprises a tokenized representation of a fixed-income instrument.

41. The non-transitory computer-readable medium of claim 31, further comprising instructions to:
maintain separate instances of the liquidity pool on different blockchain networks;
apply the same target price parameter across all instances; and
coordinate asset allocations between the instances.

42. The non-transitory computer-readable medium of claim 31, wherein determining the transaction-derived price comprises:
analyzing completed transactions involving the first asset;
calculating a volume-weighted average price; and
updating the price ratio based on the calculated volume-weighted average price.

43. The non-transitory computer-readable medium of claim 31, further comprising instructions to maintain a state database that records historical price ratios and phase transitions.

44. The non-transitory computer-readable medium of claim 31, further comprising instructions to maintain a state database that records allocation adjustments and trade executions.

45. The non-transitory computer-readable medium of claim 31, wherein the mathematical distribution function is configured to optimize trade execution based on liquidity levels in the liquidity pool.
